(19) United States
(12) Patent Application Publication
(10) Pub. No.: US 2026/0265015 A1
(43) Pub. Date: Sep. 10, 2026

(54) CUTTING MECHANISM, WINDING MACHINE, AND CUTTING METHOD

(71) Applicant: THE JAPAN STEEL WORKS, LTD., Shinagawa-ku, Tokyo (JP)

(72) Inventor: Takato MAEKAWA, Shinagawa-ku, Tokyo (JP)

(21) Appl. No.: 19/165,878

(22) PCT Filed: Dec. 15, 2023
(86) PCT No.: PCT/JP2023/044993

§ 371 Date: Sep. 16, 2025

(30) Foreign Application Priority Data
Mar. 30, 2023 (JP) 2023-054808

(51) Int. Cl. B65H 35/00; B65H 35/06

(52) U.S. Cl. CPC B65H 35/0086; B65H 35/06; B65H 2301/515123; B65H 2301/51532

(57) ABSTRACT

A cutting mechanism which contributes to improving the performance for cutting a film material is provided. A cutting mechanism is a cutting mechanism used in a winding machine that winds a film material, which cutting mechanism cuts the film material by moving a cutter in a left/right direction of the winding machine and includes: a guide mechanism that guides the cutter in the left/right direction of the winding machine; a driving mechanism that moves the cutter in the left/right direction of the winding machine; and a holding mechanism that holds the cutter at an initial position. The holding mechanism includes a first magnet provided in the cutter and a second magnet provided in a part of the winding machine that is stopped when the cutter moves, and the first magnet and the second magnet are magnetically connected to each other at the initial position.

### TECHNICAL FIELD

The present disclosure relates to a cutting mechanism, a winding machine, and a cutting method.

### BACKGROUND ART

In general, a winding machine is used to wind a film material such as a long resin film in a roll form. For example, as disclosed in Patent Literature 1, when the winding of a film material is shifted from a first winding core to a second winding core, a cutter is moved in the left/right direction of a winding machine, to thereby cut the film material between the first winding core and the second winding core.

### CITATION LIST

### Patent Literature

Patent Literature 1: Japanese Unexamined Patent Application Publication No. 2019-59587

### SUMMARY OF INVENTION

### Technical Problem

The applicant has found the following problem. As shown in FIG. 10, when an ordinary winding machine reciprocates a cutter 66 along a guide rail 62a in the left/right direction of the winding machine and returns it to its initial position, the winding machine, for example, brings the cutter 66 into contact with a receiving mechanism 64 at its initial position to stop it in some cases.

In this case, as shown in FIG. 10, the cutter 66 receives a reaction force from the receiving mechanism 64 and the cutter 66 cannot be accurately stopped at its initial position. That is, the position at which the cutter 66 stops may differ each time a film material is cut.

Therefore, the position at which the cutter 66 starts moving to cut the film material differs each time the film material is cut, and as a result, the acceleration distance of the cutter 66 differs and hence variations in the speed at which the film material is cut occur, so that the cutting surface of the film material may be affected.

The present disclosure has been made in view of the above-described problem and provides a cutting mechanism, a winding machine, and a cutting method which contribute to improving the performance for cutting a film material.

### Solution to Problem

A cutting mechanism according to an aspect of the present disclosure is a cutting mechanism used in a winding machine configured to wind a film material in a roll form, the cutting mechanism being configured to cut the film material by moving a cutter in a left/right direction of the winding machine and including:
a guide mechanism configured to guide the cutter in the left/right direction of the winding machine;
a driving mechanism configured to move the cutter in the left/right direction of the winding machine; and
a holding mechanism configured to hold the cutter at a preset initial position,
in which the holding mechanism includes a first magnet provided in the cutter and a second magnet provided in a part of the winding machine that is stopped when the cutter moves, and the first magnet and the second magnet are magnetically connected to each other at the initial position.

A winding machine according to an aspect of the present disclosure includes the above-described cutting mechanism.

A cutting method according to an aspect of the present disclosure is a cutting method for cutting a film material wound in a roll form by moving a cutter in a left/right direction of a winding machine,
in which when the cutter has reciprocated in the left/right direction of the winding machine and then returned to a preset initial position, a first magnet provided in the cutter and a second magnet provided in a part of the winding machine that is stopped when the cutter moves are magnetically connected to each other, and the cutter is held at the initial position.

### Advantageous Effects of Invention

According to the present disclosure, it is possible to provide a cutting mechanism, a winding machine, and a cutting method which contribute to improving the performance for cutting a film material.

### BRIEF DESCRIPTION OF DRAWINGS

FIG. 1 is a diagram showing a configuration of a winding machine according to an embodiment when viewed from the side thereof;

FIG. 2 is a diagram showing a configuration of a first driving mechanism of a cutting mechanism in the winding machine according to the embodiment;

FIG. 3 is a diagram showing a holding mechanism and the like of the cutting mechanism in the winding machine according to the embodiment;

FIG. 4 is a diagram for explaining a flow in which the winding of a film material is shifted from a first winding core to a second winding core using the winding machine according to the embodiment;

FIG. 5 is a diagram for explaining the flow in which the winding of the film material is shifted from the first winding core to the second winding core using the winding machine according to the embodiment;

FIG. 6 is a diagram for explaining the flow in which the winding of the film material is shifted from the first winding core to the second winding core using the winding machine according to the embodiment;

FIG. 7 is a diagram for explaining the flow in which the winding of the film material is shifted from the first winding core to the second winding core using the winding machine according to the embodiment;

FIG. 8 is a diagram showing a state where the film material is pulled into the second winding core using a pulling mechanism of the winding machine according to the embodiment;

FIG. 9 is a diagram for explaining a position at which a cutter stops in the winding machine according to the embodiment; and

FIG. 10 is a diagram for explaining a position at which a cutter stops in an ordinary winding machine.

### DESCRIPTION OF EMBODIMENTS

Specific embodiments to which the present disclosure is applied will be described hereinafter in detail with reference to the drawings. However, the present disclosure is not limited to the following embodiments. Further, for the clarification of the description, the following descriptions and drawings are simplified as appropriate.

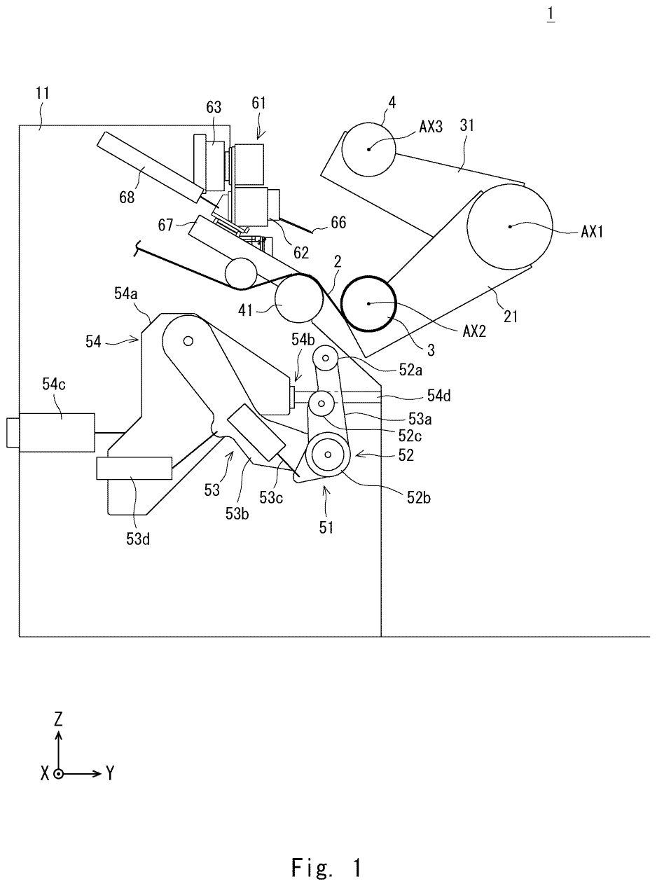

First, a configuration of a winding machine according to this embodiment will be described. FIG. 1 is a diagram showing the configuration of the winding machine according to this embodiment when viewed from the side thereof. Note that FIG. 1 is simplified for the sake of clarity and is partially a perspective view.

The following description will be given using a three-dimensional (XYZ) coordinate system in order to clarify the description. In this example, the X-axis positive side is a right side of the winding machine and the X-axis negative side is a left side of the winding machine. The Y-axis positive side is a front side of the winding machine and a downstream side in a direction in which a film material is fed, and the Y-axis negative side is a rear side of the winding machine and an upstream side in a direction in which a film material is fed. The Z-axis positive side is an upper side of the winding machine, and the Z-axis negative side is a lower side of the winding machine.

As shown in FIG. 1, a winding machine 1 according to this embodiment is suitably used to wind a film material 2, such as a long resin film, in a roll form. As shown in FIG. 1, the winding machine 1 includes first support parts 21, second support parts 31, a feeding roller 41, a pulling mechanism 51, and a cutting mechanism 61.

Note that the first support parts 21, the second support parts 31, the feeding roller 41, and the pulling mechanism 51 are substantially plane-symmetry with respect to a plane that passes through the center of a first winding core 3, which is being supported by the first support parts 21 as will be described later, in the X-axis direction and is parallel to the YZ plane. Therefore, the configuration on the X-axis negative side may be described as a representative example.

The first support parts 21 support the first winding core 3 as shown in FIG. 1. Specifically, the first support parts 21 are disposed at intervals in the X-axis direction in order to support respective ends of the first winding core 3 on the X-axis positive side and the X-axis negative side, and each of them has, for example, an arm shape that is long in one axial direction when viewed from the X-axis direction. The first winding core 3 is a core member for winding the film material 2, and is, for example, a cylindrical member.

Further, one end of the first support part 21 is connected to a frame part 11 of the winding machine 1 in such a manner that it is rotatable around the X-axis, and the first support part 21 is rotated by a driving force of a first driving mechanism (not shown).

Note that the frame part 11 of the winding machine 1 is not an essential part for the present disclosure, and a description thereof will thus be omitted. However, the frame part 11 preferably has a shape which enables other members of the winding machine 1 to be supported and does not obstruct operations of the other members.

A chuck part to which the first winding core 3 is attached and from which it is detached is provided in the other end of the first support part 21. The first winding core 3 is supported by the first support part 21 so as to extend in the X-axis direction in a state where the end of the first winding core 3 is attached to the chuck part of the first support part 21.

Further, the first support part 21 is configured so as to be able to, in a state where the end of the first winding core 3 is attached to the chuck part of the first support part 21, transmit a driving force to the first winding core 3 through the chuck part from a second driving mechanism (not shown) so that the first winding core 3 can rotate around the X-axis.

At this time, for example, the first winding core 3 can rotate counterclockwise when viewed from the X-axis positive side. By this configuration, the first support part 21 can support the first winding core 3 in such a manner that it can revolve around the X-axis and that it can rotate.

The second support parts 31 support a second winding core 4 as shown in FIG. 1. Specifically, the second support parts 31 are disposed at intervals in the X-axis direction in order to support respective ends of the second winding core 4 on the X-axis positive side and the X-axis negative side, and each of them has, for example, an arm shape that is long in one axial direction when viewed from the X-axis direction. The second winding core 4 is a core member for winding the film material 2, and is, for example, a cylindrical member.

Further, one end of the second support part 31 is connected to the frame part 11 of the winding machine 1 in such a manner that it is rotatable around the X-axis, and the second support part 31 is rotated by a driving force of a third driving mechanism (not shown). At this time, as shown in FIG. 1, the first support part 21 and the second support part 31 are rotatable around the same rotation axis AX1, and are disposed so that they do not interfere with each other when they are rotated relative to each other.

A chuck part to which the second winding core 4 is attached and from which it is detached is provided in the other end of the second support part 31. The second winding core 4 is supported by the second support part 31 so as to extend in the X-axis direction in a state where the end of the second winding core 4 is attached to the chuck part of the second support part 31.

At this time, as shown in FIG. 1, a distance between a central axis AX2 of the first winding core 3 which is being supported by the first support part 21 and the rotation axis AX1 may be substantially equal to a distance between a central axis AX3 of the second winding core 4 which is being supported by the second support part 31 and the rotation axis AX1.

The second support part 31 is configured so as to be able to, in a state where the end of the second winding core 4 is attached to the chuck part of the second support part 31, transmit a driving force to the second winding core 4 through the chuck part from a fourth driving mechanism (not shown) so that the second winding core 4 can rotate around the X-axis.

At this time, for example, the second winding core 4 can rotate counterclockwise when viewed from the X-axis positive side. By this configuration, the second support part 31 can support the second winding core 4 in such a manner that it can revolve around the X-axis and that it can rotate.

As shown in FIG. 1, the feeding roller 41 is a fade roller or a guide roller disposed on the Y-axis negative side with respect to the first support part 21 and the second support part 31 in order to feed the film material 2 to the first winding core 3 or the second winding core 4. The feeding roller 41 extends in the X-axis direction and is supported by the frame part 11 of the winding machine 1 in such a manner that it is rotatable around the X-axis.

The pulling mechanism 51, the details of which will be described later, pulls the film material 2 toward the side of the second winding core 4 so that the film material 2 is wound around the second winding core 4 in the direction in which the second winding core 4 rotates in a state where the first winding core 3 revolves around the X-axis and thus is spaced apart from the feeding roller 41 toward the Y-axis positive side and the second winding core 4 revolves around the X-axis and thus is in contact with the film material 2 between the first winding core 3 and the feeding roller 41.

As shown in FIG. 1, for example, the pulling mechanism 51 is disposed on the Z-axis negative side with respect to the feeding roller 41 in a state where the film material 2 is not pulled toward the side of the second winding core 4. Further, in the X-axis direction, the pulling mechanism 51 is disposed between the first support part 21 and the second support part 31 on the X-axis positive side and the first support part 21 and the second support part 31 on the X-axis negative side.

Note that, it is sufficient that the first support part 21 which is supporting the first winding core 3, the second support part 31 which is supporting the second winding core 4, and the pulling mechanism 51 be disposed so that they can operate without interfering with each other.

As shown in FIG. 1, the pulling mechanism 51 includes a contact part 52, an arm mechanism 53, and a slide mechanism 54. The contact part 52 comes into contact with the film material 2 when the film material 2 is pulled toward the side of the second winding core 4. The contact part 52 includes a first roller 52a, a second roller 52b, and a third roller 52c.

As shown in FIG. 1, the first roller 52a, the second roller 52b, and the third roller 52c extend in the X-axis direction, and their central axes are substantially linearly arranged when viewed from the X-axis direction. The first roller 52a, the second roller 52b, and the third roller 52c described above may be composed of fade rollers, guide rollers, or a combination thereof.

As shown in FIG. 1, the arm mechanism 53 includes first arm parts 53a, second arm parts 53b, a first cylinder 53c, and a second cylinder 53d. Each of the first arm parts 53a is a plate-like member substantially parallel to the YZ plane, and is, for example, long in one axial direction when viewed from the X-axis direction. The first arm parts 53a are disposed at intervals in the X-axis direction in order to support respective ends of the first roller 52a, the second roller 52b, and the third roller 52c on the X-axis positive side and the X-axis negative side.

As shown in FIG. 1, the first roller 52a is rotatably provided at one end of the first arm part 53a. The second roller 52b is rotatably provided at the other end of the first arm part 53a. Further, the third roller 52c is rotatably provided in a part of the first arm part 53a between one end and the other end thereof.

As shown in FIG. 1, the second arm part 53b is a plate-like member substantially parallel to the YZ plane, and, for example, is bent counterclockwise when viewed from the X-axis positive side. The second arm parts 53b are disposed at intervals in the X-axis direction. Further, one end of the second arm part 53b is connected to the other end of the first arm part 53a in such a manner that it is rotatable around the X-axis. Further, the other end of the second arm part 53b is connected to the slide mechanism 54 in such a manner that it is rotatable around the X-axis.

The first cylinder 53c is a driving source for rotating the first arm part 53a around the X-axis relative to the second arm part 53b. One end of the first cylinder 53c is connected to the other end of the first arm part 53a in such a manner that it is rotatable around the X-axis. Further, the other end of the first cylinder 53c is connected to the second arm part 53b in such a manner that it is rotatable around the X-axis. However, any driving means which can rotate first arm part 53a around the X-axis relative to the second arm part 53b may be used.

The second cylinder 53d is a driving source for rotating the second arm part 53b around the X-axis relative to the slide mechanism 54. One end of the second cylinder 53d is connected to the second arm part 53b in such a manner that it is rotatable around the X-axis. Further, the other end of the second cylinder 53d is connected to the slide mechanism 54 in such a manner that it is rotatable around the X-axis. However, any driving means which can rotate the second arm part 53b around the X-axis relative to the slide mechanism 54 may be used.

The slide mechanism 54 moves the contact part 52 and the arm mechanism 53 in the Y-axis direction. As shown in FIG. 1, the slide mechanism 54 includes slide plates 54a, a linear rail 54b, and a driving mechanism 54c. The slide plates 54a are plate-like members substantially parallel to the YZ plane, and are disposed at intervals in the X-axis direction. Further, the other end of the second arm part 53b is connected to a surface of the slide plate 54a on the inward side of the winding machine 1.

Like an ordinary linear rail, the linear rail 54b includes, as shown in FIG. 1, a guide rail 54d and a slider (not shown) that slides along the guide rail 54d. The guide rail 54d extends in the Y-axis direction, and is fixed to a surface of the frame part 11 of the winding machine 1 on the inward side of the winding machine 1. The slider is fixed to a surface of the slide plate 54a on the outward side of the winding machine 1.

The driving mechanism 54c slides the slider along the guide rail 54d. The driving mechanism 54c, for example, can be composed of a linear motion mechanism using a ball screw etc., and is connected to the slider so that a linear motion can be transmitted.

The driving mechanism 54c is fixed to the surface of the frame part 11 of the winding machine 1 on the inward side of the winding machine 1. By the above configuration, the contact part 52 and the arm mechanism 53 are movable in the Y-axis direction through the slide plate 54a by operating the driving mechanism 54c. However, any driving means which can move the contact part 52 and the arm mechanism 53 in the Y-axis direction may be used.

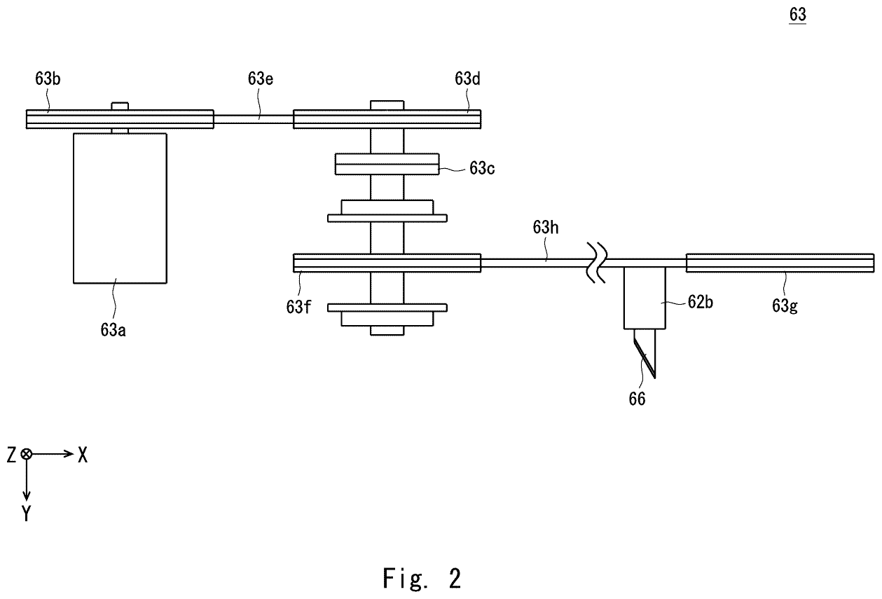

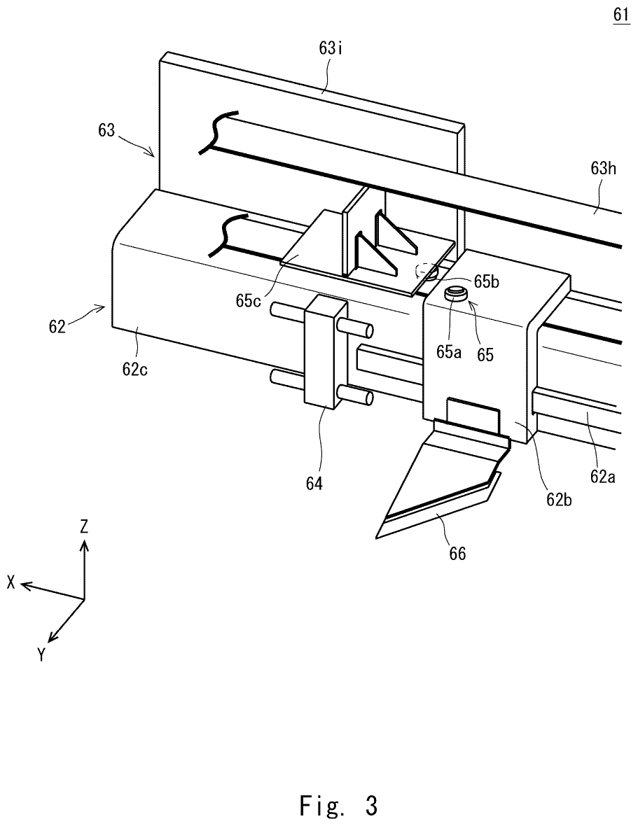

FIG. 2 is a diagram showing a configuration of a first driving mechanism of the cutting mechanism in the winding machine according to this embodiment. FIG. 3 is a diagram showing a holding mechanism and the like of the cutting mechanism in the winding machine according to this embodiment. As shown in FIG. 1, for example, the cutting mechanism 61 is disposed on the Y-axis negative side with respect to the first support part 21 and the second support part 31 and on the Z-axis positive side with respect to the slide mechanism 54 of the pulling mechanism 51.

As shown in FIGS. 1 to 3, the cutting mechanism 61 includes a first guide mechanism 62, a first driving mechanism 63, the receiving mechanism 64, a holding mechanism 65, the cutter 66, second guide mechanisms 67, and a second driving mechanism 68.

As shown in FIG. 3, the first guide mechanism 62 includes the guide rail 62a and a holder 62b. The guide rail 62a extends in the X-axis direction, and is fixed, for example, to a surface of a beam member 62c on the Y-axis positive side, the beam member 62c extending in the X-axis direction between the frame part 11 of the winding machine 1 on the X-axis positive side and the frame part 11 of the winding machine 1 on the X-axis negative side. Note that the beam member 62c is, for example, a rectangular member.

The holder 62b is slidably engaged with the guide rail 62a along the guide rail 62a. The holder 62b has, for example, an inverted L-shape when viewed from the X-axis direction, and includes a horizontal part that covers a surface of the beam member 62c on the Z-axis positive side, and a vertical part that extends from end of the horizontal part on the Y-axis positive side to the Z-axis negative side and covers a surface of the beam member 62c on the Y-axis positive side, and the guide rail 62a is engaged with a groove part formed in the vertical part.

The first driving mechanism 63 moves the holder 62b along the guide rail 62a. As shown in FIG. 2, the first driving mechanism 63 includes a motor 63a, a first pulley 63b, a clutch 63c, a second pulley 63d, a first belt 63e, a third pulley 63f, a fourth pulley 63g, and a second belt 63h.

The motor 63a is fixed, for example, to the end of the beam member 62c in the first guide mechanism 62 on the X-axis negative side through a first bracket (not shown), and a drive shaft of the motor 63a protrudes toward the Y-axis negative side. As shown in FIG. 2, the first pulley 63b is fixed to the drive shaft of the motor 63a.

The clutch 63c may be, for example, any ordinary clutch mechanism capable of performing switching between transmission and interruption of a driving force. The clutch 63c is fixed, for example, to the end of the beam member 62c in the first guide mechanism 62 on the X-axis negative side, and near the motor 63a through a second bracket (not shown). However, the clutch 63c may be omitted.

As shown in FIG. 2, the second pulley 63d is fixed, for example, to an input shaft that protrudes from the clutch 63c toward the Y-axis negative side. The first belt 63e is an endless belt and is extended between the first pulley 63b and the second pulley 63d. The first pulley 63b, the second pulley 63d, and the first belt 63e described above form an input-side transmission part of the first driving mechanism 63.

The third pulley 63f is fixed to an output shaft that protrudes from the clutch 63c toward the Y-axis positive side. The fourth pulley 63g is fixed to the end of the beam member 62c in the first guide mechanism 62 on the X-axis positive side through a third bracket 63i (see FIG. 3) in such a manner that it is rotatable around the Y-axis.

The second belt 63h is an endless belt, and is extended between the third pulley 63f and the fourth pulley 63g as shown in FIG. 2. The third pulley 63f, the fourth pulley 63g, and the second belt 63h described above form an output-side transmission part of the first driving mechanism 63.

The holder 62b of the first guide mechanism 62 is fixed to the second belt 63h. Thus, a driving force of the motor 63a is transmitted to the second belt 63h through the first pulley 63b, the first belt 63e, the second pulley 63d, the clutch 63c, and the third pulley 63f, and the holder 62b moves in the X-axis direction in accordance with the movement of the second belt 63h, which is rotated between the third pulley 63f and the fourth pulley 63g, in the X-axis direction.

That is, the first pulley 63b, the clutch 63c, the second pulley 63d, the first belt 63e, the third pulley 63f, the fourth pulley 63g, and the second belt 63h form a drive transmission part that transmits the driving force of the motor 63a to the holder 62b of the first guide mechanism 62.

Note that the weight of the second pulley 63d is preferably heavier than that of each of the first pulley 63b, the third pulley 63f, and the fourth pulley 63g. By this configuration, a large amount of rotational energy stored by the rotation of the second pulley 63d can be transmitted to the holder 62b through the clutch 63c. That is, the second pulley 63d functions as an amplification part that amplifies the driving force of the motor 63a.

As described above, the receiving mechanism 64 comes into contact with the holder 62b that moves in the X-axis direction at the initial position of the holder 62b and receives the holder 62b. For example, when the end of the beam member 62c of the first guide mechanism 62 on the X-axis positive side is set as the initial position of the holder 62b, the receiving mechanism 64 is fixed to the end of the beam member 62c on the X-axis positive side as shown in FIG. 3.

Thus, the receiving mechanism 64 can receive the holder 62b that moves to the X-axis positive side at the initial position of the holder 62b. However, the position of the receiving mechanism 64 may be changed in accordance with the initial position of the holder 62b as appropriate.

The holding mechanism 65 temporarily holds the holder 62b of the first guide mechanism 62 at the initial position of the holder 62b. As shown in FIG. 3, the holding mechanism 65 includes a first magnet 65a and a second magnet 65b which can be magnetically connected to each other.

At this time, the magnetic connection force between the first magnet 65a and the second magnet 65b is a magnetic connection force with which the magnetic connection between the first magnet 65a and the second magnet 65b may be released when the driving force of the motor 63a of the first driving mechanism 63 is transmitted to the holder 62b.

However, when the first magnet 65a and the second magnet 65b are made of electromagnets, the magnetic connection force can be controlled by controlling the currents supplied to the first magnet 65a and the second magnet 65b.

The first magnet 65a is fixed, for example, to the holder 62b as shown in FIG. 3. The first magnet 65a is fixed, for example, to a surface of the horizontal part of the holder 62b on the Z-axis positive side. The second magnet 65b is fixed to a part of the winding machine 1 that is stopped when the holder 62b moves in such a manner that second magnet 65b is magnetically connected to the first magnet 65a in a state where the holder 62b of the first guide mechanism 62 is disposed at its initial position.

As shown in FIG. 3, for example, the second magnet 65b is fixed to the third bracket 63i for fixing the fourth pulley 63g to the beam member 62c of the first guide mechanism 62 through a bracket 65c. Note that the bracket 65c has, for example, an inverted T-shape when viewed from the Y-axis direction, and includes a vertical part that extends in the Z-axis direction and a horizontal part that protrudes from an end of the vertical part on the Z-axis negative side toward the Y-axis positive and negative sides.

Further, as shown in FIG. 3, the bracket 65c protrudes toward the Y-axis positive side from the third bracket 63i for fixing the fourth pulley 63g to the beam member 62c of the first guide mechanism 62 between a part of the second belt 63h in the first driving mechanism 63 on the Z-axis positive side and a part of the second belt 63h in the first driving mechanism 63 on the Z-axis negative side. The second magnet 65b is fixed, for example, to a surface of the horizontal part of the bracket 65c on the Z-axis negative side.

Thus, for example, the first magnet 65a and the second magnet 65b overlap each other in the Z-axis direction and are magnetically connected to each other in a state where the holder 62b of the first guide mechanism 62 disposed at its initial position, and hence the holder 62b can be temporarily held at its initial position. Note that the positions of the first magnet 65a and the second magnet 65b are not limited to those described above, and may be any positions in which the holder 62b can be temporarily held at its initial position.

The cutter 66 protrudes from the holder 62b of the first guide mechanism 62 toward the Y-axis positive side. As will be described later, each of the second guide mechanisms 67 guides the cutter 66 in such a manner that the cutter 66 comes into contact with the film material 2 disposed between the first roller 52a of the pulling mechanism 51 and the second winding core 4 in a state where the pulling mechanism 51 pulls the film material 2 toward the side of the second winding core 4.

Each of the second guide mechanisms 67 may be composed of an ordinary linear rail and they are disposed at intervals in the X-axis direction. Further, a guide rail of the second guide mechanism 67 is fixed to the frame part 11 of the winding machine 1, and a slider that slides along the guide rail is fixed to the beam member 62c of the first guide mechanism 62.

At this time, for example, the guide rail of the second guide mechanism 67 is disposed so as to be gradually inclined in the Z-axis negative side direction toward the Y-axis positive side so that the cutter 66 can be guided toward the film material 2 disposed between the first roller 52a of the pulling mechanism 51 and the second winding core 4 through the first guide mechanism 62 as described above.

The second driving mechanism 68 moves the slider of the second guide mechanism 67. The second driving mechanism 68 may be, for example, a cylinder as shown in FIG. 1, and one end of the second driving mechanism 68 is connected to the slider of the second guide mechanism 67, and the other end of the second driving mechanism 68 is connected to the frame part 11 of the winding machine 1.

Thus, the cutter 66 can be made to move along the guide rail of the second guide mechanism 67 through the slider of the second guide mechanism 67 and the first guide mechanism 62 by the expansion and contraction of the second driving mechanism 68.

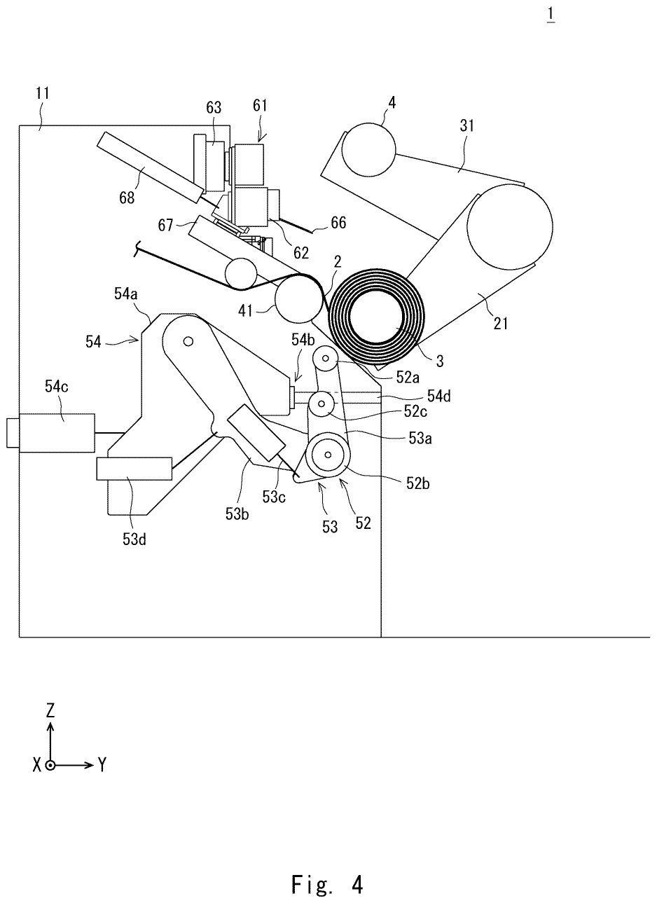

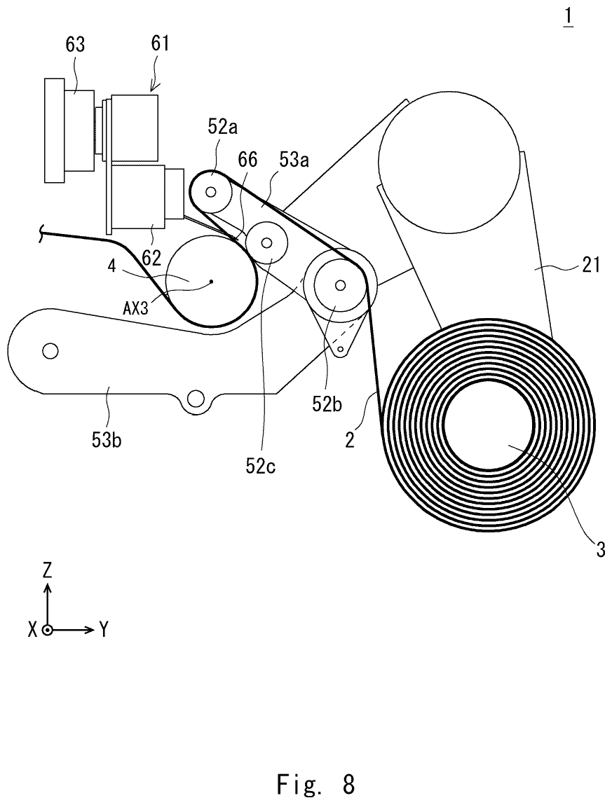

Next, a flow in which the winding of the film material 2 is shifted from the first winding core 3 to the second winding core 4 using the winding machine 1 according to this embodiment will be described. Each of FIGS. 4 to 7 is a diagram for explaining the flow in which the winding of the film material is shifted from the first winding core to the second winding core using the winding machine according to this embodiment. FIG. 8 is a diagram showing a state where the film material is pulled into the second winding core using the pulling mechanism of the winding machine according to this embodiment. Note that each of FIGS. 4 to 7 is simplified for the sake of clarity and is partially a perspective view. FIG. 8 is also simplified for the sake of clarity.

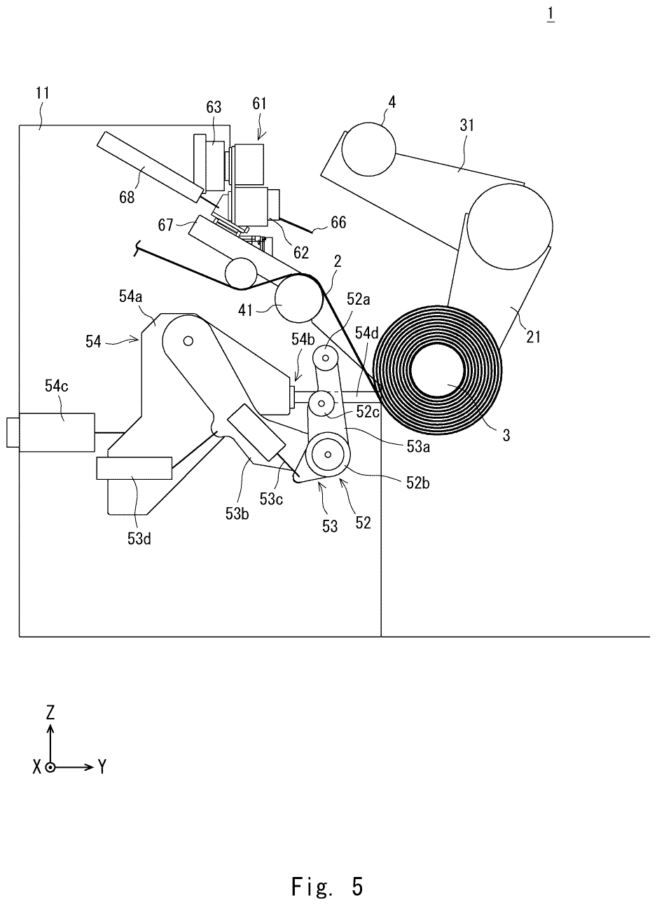

First, as shown in FIG. 1, the first winding core 3 rotates to wind the film material 2 fed through the feeding roller 41. Then, as the winding of the film material 2 by the first winding core 3 proceeds, the first winding core 3 revolves counterclockwise through the first support part 21 as shown in FIGS. 4 and 5 when viewed from the X-axis positive side.

At this time, the second winding core 4 is disposed, for example, on the Z-axis positive side with respect to the first winding core 3. Further, when viewed from the X-axis positive side, for example, the first arm part 53a of the pulling mechanism 51 has been rotated most counterclockwise with respect to the second arm part 53b, and the second arm part 53b has been rotated most clockwise with respect to the slide plate 54a of the pulling mechanism 51.

Further, for example, the slide plate 54a of the pulling mechanism 51 is disposed on the most Y-axis negative side. Further, for example, the holder 62b of the first guide mechanism 62 is disposed at its initial position (e.g., the end of the guide rail 62a of the first guide mechanism 62 on the X-axis positive side) in a state where the first guide mechanism 62 of the cutting mechanism 61 disposed on the most Y-axis negative side.

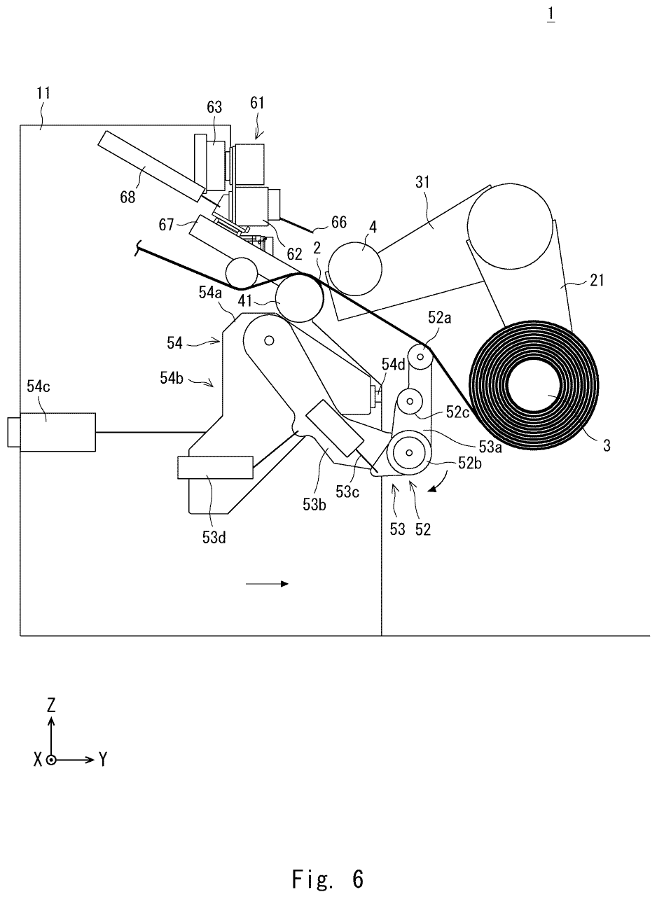

When the amount of the winding of the film material 2 by the first winding core 3 approaches a predetermined amount, as shown in FIG. 6, when viewed from the X-axis positive side, the first winding core 3 revolves counterclockwise through the first support part 21, the second winding core 4 revolves counterclockwise through the second support part 31, and the second winding core 4 comes into contact with the film material 2 between the first winding core 3 and the feeding roller 41 from the Z-axis positive side. At this time, the second winding core 4 is rotating.

Next, the driving mechanism 54c of the pulling mechanism 51 operates, so that the contact part 52 and the arm mechanism 53 moves to the Y-axis positive side through the slide plate 54a. Then, the first cylinder 53c of the pulling mechanism 51 is contracted, the first arm part 53a is rotated clockwise when viewed from the X-axis positive side, and the first roller 52a comes into contact with the film material 2 between the first winding core 3 and the second winding core 4 from the Z-axis negative side. At this time, the first arm part 53a is bent counterclockwise relative to the second arm part 53b when viewed from the X-axis positive side.

Next, the second cylinder 53d of the pulling mechanism 51 is extended, the second arm part 53b is rotated counterclockwise when viewed from the X-axis positive side, and the first roller 52a pulls the film material 2 between the first winding core 3 and the second winding core 4 toward the side of the second winding core 4 so that a part of the film material 2 between the first winding core 3 and the second winding core 4 on the Y-axis negative side with the first roller 52a positioned therebetween is wound around the second winding core 4 in the direction in which the second winding core 4 rotates.

Next, the second driving mechanism 68 of the cutting mechanism 61 is extended, so that the first guide mechanism 62 and the like move along the guide rail of the second guide mechanism 67 toward the Y-axis positive side. At this time, the cutter 66 of the cutting mechanism 61 is disposed outside the first support part 21 and the second support part 31 in the X-axis direction when viewed from the Y-axis direction. For example, it is disposed on the X-axis positive side with respect to the film material 2 when viewed from the Y-axis direction.

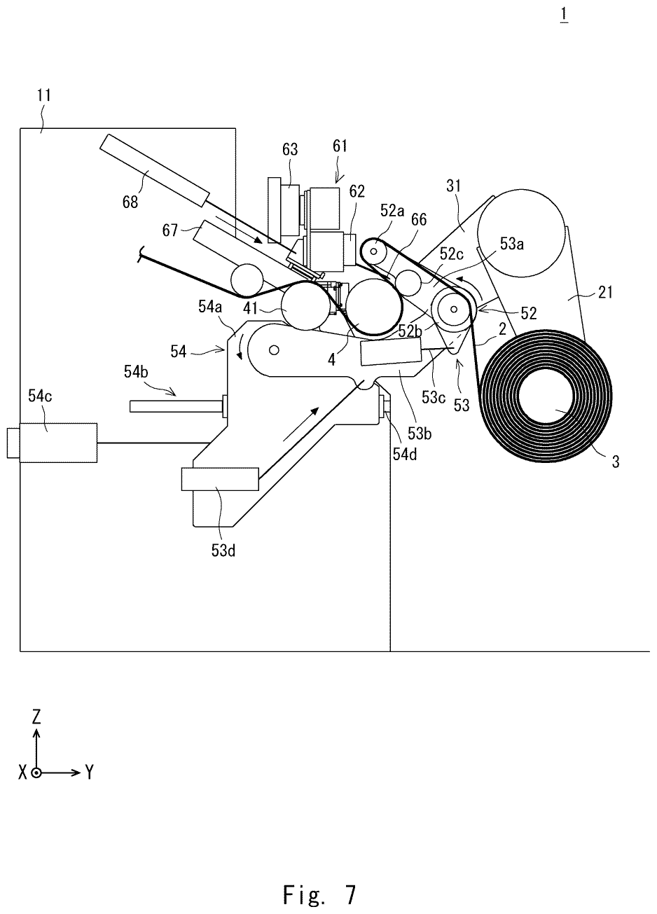

Next, the first cylinder 53c of the pulling mechanism 51 is extended, and as shown in FIG. 7, the first arm part 53a is rotated counterclockwise when viewed from the X-axis positive side, and the first roller 52a pulls the film material 2 between the first winding core 3 and the second winding core 4 toward the side of the second winding core 4 so that the part of the film material 2 between the first winding core 3 and the second winding core 4 on the Y-axis negative side with the first roller 52a positioned therebetween further is wound around the second winding core 4 in the direction in which the second winding core 4 rotates.

That is, the pulling mechanism 51 moves the first roller 52a to wind the film material 2 between the first winding core 3 and the second winding core 4 around the second winding core 4 along the direction in which the second winding core 4 rotates. At this time, an end of the cutter 66 on the Y-axis positive side is disposed so as to overlap the film material 2 disposed between the second winding core 4 and the first roller 52a when viewed from the X-axis direction.

Note that, as shown in FIG. 8, an end of the first roller 52a of the pulling mechanism 51 on the Y-axis negative side is preferably disposed on the Y-axis negative side, which is the side in the direction in which the second winding core 4 rotates with respect to the central axis AX3 of the second winding core 4, in a state where the first roller 52a is disposed on the Z-axis positive side with respect to the second winding core 4.

By this configuration, the Z-axis positive side end of the part of the film material 2 between the first winding core 3 and the second winding core 4 on the Y-axis negative side with the first roller 52a positioned therebetween may be disposed on the Y-axis negative side with respect to the central axis AX3 of the second winding core 4, and as will be described later, when the film material 2 disposed between the second winding core 4 and the first roller 52a is cut, a tip of the film material 2 can be dropped by its own weight in such a manner that the tip of the film material 2 is pulled by the rotation of the second winding core 4.

Further, as shown in FIG. 8, the third roller 52c of the pulling mechanism 51 preferably presses the film material 2 against the side of the second winding core 4. By doing so, a state where the film material 2 is wound around the second winding core 4 can be reliably maintained.

At this time, when viewed from the X-axis direction, the third roller 52c preferably presses the film material 2 against the side of the second winding core 4 near a contact point where a straight line formed along the film material 2 between the second winding core 4 and the first roller 52a of the pulling mechanism 51 comes into contact with the second winding core 4. By doing so, the entry of air bubbles and the stress on the film material 2 when the film material 2 is wound around the second winding core 4 can be reduced.

Further, as shown in FIG. 8, when viewed from the X-axis direction, one end of the second arm part 53b of the pulling mechanism 51 is preferably disposed on the Z-axis positive side with respect to the central axis AX3 of the second winding core 4 in accordance with the bent shape of the second arm part 53b. By doing so, when the first arm part 53a is rotated toward the side of the second winding core 4, the part of the film material 2 between the first winding core 3 and the second winding core 4 on the Y-axis negative side with the first roller 52a positioned therebetween can be wound more widely around the second winding core 4.

Next, the motor 63a is rotated in a state where the clutch 63c of the cutting mechanism 61 is disengaged in advance, and when the rotation speed of the motor 63a reaches or exceeds a preset rotation speed, the clutch 63c is engaged. Thus, the driving force of the motor 63a is transmitted to the cutter 66 through the first pulley 63b, the first belt 63e, the second pulley 63d, the clutch 63c, the third pulley 63f, the second belt 63h, and the holder 62b.

Then, the magnetic connection between the first magnet 65a and the second magnet 65b of the holding mechanism 65 is released, and the cutter 66 moves to the X-axis negative side to cut the film material 2 disposed between the second winding core 4 and the first roller 52a of the pulling mechanism 51. At this time, when the second pulley 63d functions as the amplification part, a large amount of rotational energy can be transmitted to the cutter 66, and the cutter 66 accelerated from the outside of the first support part 21 and the second support part 31 cuts the film material 2 so as to cross it. Thus, the film material 2 can be satisfactorily cut.

After that, the winding of the film material 2 by the second winding core 4 is started, and the winding of the film material 2 is shifted from the first winding core 3 to the second winding core 4. At this time, the film material 2 disposed between the second winding core 4 and the first roller 52a of the pulling mechanism 51 may be cut near the second winding core 4.

When the winding of the film material 2 is shifted from the first winding core 3 to the second winding core 4 as described above, the pulling mechanism 51 pulls the film material 2 between the first winding core 3 and the second winding core 4 toward the side of the second winding core 4 so that the part of the film material 2 between the first winding core 3 and the second winding core 4 on the Y-axis negative side with the first roller 52a positioned therebetween is wound around the second winding core 4 in the direction in which the second winding core 4 rotates.

Therefore, the area where the film material 2 comes into contact with the second winding core 4 when the winding of the film material 2 is shifted from the first winding core 3 to the second winding core 4 is larger than that of an ordinary winding machine, and the film material 2 can be satisfactorily wound by the second winding core 4. After that, the states shown in FIGS. 1 and 4 to 7 are repeated while the first winding core 3 and the second winding core 4 are interchanged, whereby the film material 2 can be continuously wound.

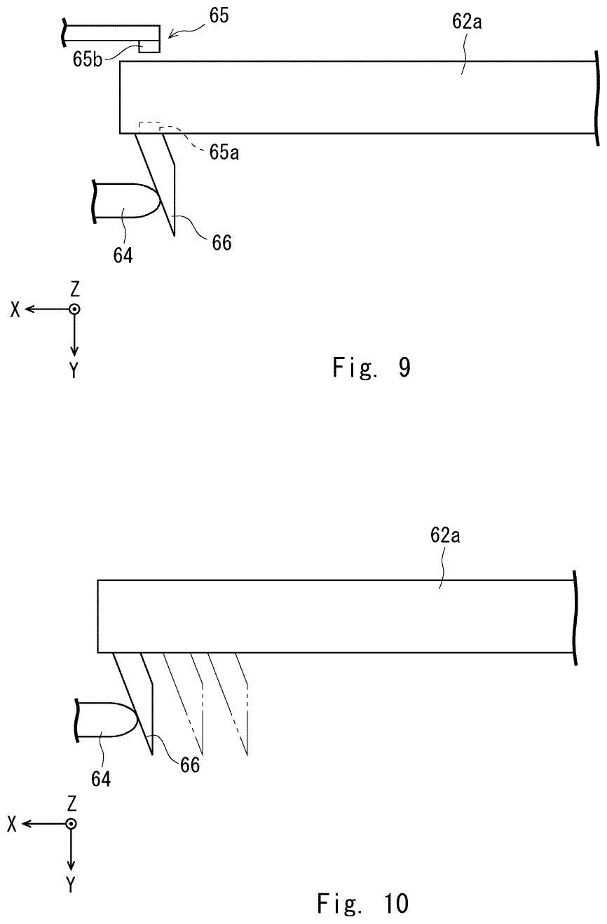

FIG. 9 is a diagram for explaining a position at which the cutter stops in the winding machine according to this embodiment. If the holding mechanism 65 is not provided, the holder 62b receives a reaction force from the receiving mechanism 64, and as shown in FIG. 10, not only the holder 62b, but also the cutter 66 cannot be accurately stopped at their initial positions. That is, the position at which the cutter 66 stops may differ each time the film material 2 is cut.

Therefore, the position at which the cutter 66 starts moving toward the X-axis negative side to cut the film material 2 differs each time the film material 2 is cut, and as a result, the acceleration distance of the cutter 66 differs and hence variations in the speed at which the film material 2 is cut occur, so that the cutting surface of the film material 2 may be affected.

On the contrary, since the winding machine 1 according to this embodiment includes the holding mechanism 65, the holder 62b can be accurately held at its initial position by the magnetic connection force of the holding mechanism 65 even if the holder 62b comes into contact with the receiving mechanism 64 and receives a reaction force from the receiving mechanism 64 when the holder 62b is moved to the X-axis positive side and returned to its initial position after the cutter 66 of the cutting mechanism 61 cuts the film material 2 as shown in FIG. 9.

Thus, the position at which the cutter 66 starts moving toward the X-axis negative side can be made substantially the same each time the film material 2 is cut. Thus, it can be ensured that the acceleration distance of the cutter 66 be substantially the same each time the film material 2 is cut, and variations in the speed at which the film material 2 is cut can be reduced, so that it is possible to improve the performance for cutting the film material 2.

As described above, in the cutting mechanism 61, the winding machine 1, and the winding method according to this embodiment, it can be ensured that the acceleration distance of the cutter 66 be substantially the same each time the film material 2 is cut and variations in the speed at which the film material 2 is cut can be reduced, so that it is possible to improve the performance for cutting the film material 2.

Moreover, when the holding mechanism is of a contact type and configured to hold the holder 62b at its initial position, foreign substances such as fragments of a holding member may be generated when the holding member comes into contact with it. However, the holding mechanism 65 according to this embodiment is configured to hold the holder 62b at its initial position using a magnetic connection force in a noncontact manner. Therefore, the possibility that foreign substances will be generated can be reduced, and as a result, the possibility that contamination by foreign substances will occur when the film material 2 is wound can be reduced.

The present disclosure is not limited to the above-described embodiments and may be changed as appropriate without departing from the spirit of the present disclosure.

For example, the winding machine 1 according to the above embodiment is an example of a winding machine to which the cutting mechanism 61 is applied, and as components of the winding machine 1 other than the cutting mechanism 61, components of an ordinary winding machine may be applied.

For example, the first guide mechanism 62, the first driving mechanism 63, the second guide mechanism 67, and the second driving mechanism 68 of the cutting mechanism 61 according to the above embodiment are examples, and it is sufficient that components by which the cutter 66 can be moved closer to the film material 2 or moved in the X-axis direction when the film material 2 is cut be included.

For example, although the cutting mechanism 61 according to the above embodiment includes a receiving mechanism 64, it may be omitted.

This application is based upon and claims the benefit of priority from Japanese patent application No. 2023-54808, filed on Mar. 30, 2023, the disclosure of which is incorporated herein in its entirety by reference.

### REFERENCE SIGNS LIST

1 WINDING MACHINE
2 FILM MATERIAL
3 FIRST WINDING CORE
4 SECOND WINDING CORE
11 FRAME PART OF WINDING MACHINE
21 FIRST SUPPORT PART
31 SECOND SUPPORT PART
41 FEEDING ROLLER
51 PULLING MECHANISM
52 CONTACT PART, 52a FIRST ROLLER, 52b SECOND ROLLER, 52c THIRD ROLLER
53 ARM MECHANISM, 53a FIRST ARM PART, 53b SECOND ARM PART, 53c FIRST CYLINDER, 53d SECOND CYLINDER
54 SLIDE MECHANISM, 54a SLIDE PLATE, 54b LINEAR RAIL, 54c DRIVING MECHANISM, 54d GUIDE RAIL
61 CUTTING MECHANISM
62 FIRST GUIDE MECHANISM, 62a GUIDE RAIL, 62b HOLDER, 62c BEAM MEMBER
63 FIRST DRIVING MECHANISM, 63a MOTOR, 63b FIRST PULLEY, 63c CLUTCH, 63d SECOND PULLEY, 63e FIRST BELT, 63f THIRD PULLEY, 63g FOURTH PULLEY, 63h SECOND BELT, 63i THIRD BRACKET
64 RECEIVING MECHANISM
65 HOLDING MECHANISM, 65a FIRST MAGNET, 65b SECOND MAGNET, 65c BRACKET
66 CUTTER
67 GUIDE MECHANISM
68 DRIVING MECHANISM
AX1 ROTATION AXIS OF EACH OF FIRST SUPPORT PART AND SECOND SUPPORT PART
AX2 CENTRAL AXIS OF FIRST WINDING CORE
AX3 CENTRAL AXIS OF SECOND WINDING CORE

1. A cutting mechanism used in a winding machine configured to wind a film material in a roll form, the cutting mechanism being configured to cut the film material by moving a cutter in a left/right direction of the winding machine and comprising:
a guide mechanism configured to guide the cutter in the left/right direction of the winding machine;
a driving mechanism configured to move the cutter in the left/right direction of the winding machine; and
a holding mechanism configured to hold the cutter at a preset initial position,
wherein the holding mechanism includes a first magnet provided in the cutter and a second magnet provided in a part of the winding machine that is stopped when the cutter moves, and the first magnet and the second magnet are magnetically connected to each other at the initial position.

2. The cutting mechanism according to claim 1, wherein
the driving mechanism comprises a motor and a drive transmission part configured to transmit a driving force of the motor to the cutter,
the drive transmission part comprises a clutch disposed between the motor and the cutter, an input-side transmission part between the motor and the clutch, and an output-side transmission part between the clutch and the cutter, and
the input-side transmission part comprises an amplification part configured to amplify the driving force of the motor.

3. The cutting mechanism according to claim 1, wherein the cutting mechanism comprises a receiving mechanism configured to receive the cutter in a state where the cutter has reciprocated in the left/right direction of the winding machine and then returned to the initial position.

4. The cutting mechanism according to claim 1, wherein a magnetic connection between the first magnet and the second magnet is released when a driving force of the driving mechanism is transmitted to the cutter.

5. The cutting mechanism according to claim 1, wherein the first magnet and the second magnet are electromagnets.

6. The cutting mechanism according to claim 1, wherein the film material is a long resin film.

7. A winding machine comprising the cutting mechanism according to claim 1.

8. A cutting method for cutting a film material wound in a roll form by moving a cutter in a left/right direction of a winding machine,
wherein when the cutter has reciprocated in the left/right direction of the winding machine and then returned to a preset initial position, a first magnet provided in the cutter and a second magnet provided in a part of the winding machine that is stopped when the cutter moves are magnetically connected to each other, and the cutter is held at the initial position.
